(19) United States
(12) Patent Application Publication
(10) Pub. No.: US 2024/0426612 A1
(43) Pub. Date: Dec. 26, 2024

(54) METHOD FOR DETERMINING THE ORIENTATION OF A DRONE

(71) Applicant: Murata Manufacturing Co., Ltd., Nagaokakyo-shi (JP)

(72) Inventors: Antti FINNE, Vantaa (FI); Pekka KOSTIAINEN, Helsinki (FI)

(21) Appl. No.: 18/750,161

(22) Filed: Jun. 21, 2024

(30) Foreign Application Priority Data
Jun. 26, 2023 (EP) 23181415.3

(51) Int. Cl. G01C 21/18; B64U 10/14; B64U 101/30; G01C 21/16; G02B 27/64

(52) U.S. Cl. CPC G01C 21/18; B64U 10/14; G01C 21/1656; G02B 27/648; B64U 2101/30

(57) ABSTRACT

A method is provided for determining the orientation of a drone that includes a main body, a camera device with an attachment structure, and one or more MEMS gyroscopes on the camera device or the attachment structure. The method includes retrieving one or more first measurement values from one or more MEMS gyroscopes when the camera device is in a first position in relation to the main body of the drone, shifting the camera device from the first position to a second position in relation to the main body of the drone, retrieving one or more second measurement values from said one or more MEMS gyroscopes when the camera device is in the second position, and then calculating the orientation of the drone based on at least the one or more first measurement values and the one or more second measurement values.

### CROSS REFERENCE TO RELATED APPLICATIONS

This application claims priority to European Application No. 23181415.3, filed Jun. 26, 2023, the entire contents of which are hereby incorporated by reference.

### TECHNICAL FIELD

This disclosure relates to small, remote-controlled aerial vehicles, also known as drones. More specifically, the disclosure relates to methods for determining the geographical heading of a drone, which may also be considered the orientation of the drone with respect to the points of the compass.

### BACKGROUND

Drones can be used for filming, mapping, parcel delivery and many other applications. Small drones can be transported to a location of use and then launched without any kind of dedicated launch platform. Drones often include camera devices that may record images or video when the drone is in flight.

In some applications, a flying drone remains within the range of vision of the user who controls the drone. In this case, the user may steer the drone based on direct visual observation. However, there are many applications where the desired operating range of a drone exceeds the range of vision of the user. Steering based on direct visual observation is then not possible.

Drones that execute automatic or semi-automatic navigation are known. A user may program a drone to follow a predetermined route and then return to the launch point (or land at some other location). The drone needs some form of navigation system to perform this task. The system may be a GNSS receiver unit which allows the drone to navigate with the help of the Global Navigation Satellite System.

However, in order to navigate by GNSS, drones typically have to fly for a brief moment so that an initial direction of flight can be ascertained. When this initial direction is known, the flight path can gradually be corrected, and the drone can start to follow the predetermined route. But this navigation-initializing flight phase can be problematic in confined spaces, for example in cities where high buildings may restrict the possibility of free movement and block GNSS signals. The drone may have to fly above the surrounding rooftops before it can determine its geographical heading sufficiently accurately to pick up the desired route. This is inconvenient and time-consuming.

International Publication No. WO2017/094000 discloses a drone navigation system where the onboard position sensors are augmented by a pseudo-GPS signal provided by a ground-based remote sensor. However, it is cumbersome to always use an additional remote sensor when a drone is used, and the remote sensor only determines the movement of the drone relative to said sensor. If the heading of the drone is to be determined with respect to the points of the compass, then the relative position of the remote sensor with respect to the drone must first be measured with a compass.

In view of the foregoing, it would be useful to be able to determine the orientation of a drone in relation to the points of the compass without any additional remote equipment. The drone could then start following the predetermined route without an extended initialization phase.

### SUMMARY

In view of the foregoing, a method and system is provided to determine the orientation of a drone that includes a main body, a camera device that is attached to the main body with an attachment structure that enables the camera device to be moved in relation to the main body, and one or more MEMS gyroscopes. In an exemplary aspect, the method includes retrieving, by a control unit, measurement values from the one or more MEMS gyroscopes; retrieving, by the control unit, one or more first measurement values from the one or more MEMS gyroscopes when the camera device is in a first position in relation to the main body of the drone; shifting the camera device from the first position to a second position in relation to the main body of the drone; retrieving, by the control unit, one or more second measurement values from the one or more MEMS gyroscopes when the camera device is in the second position; and calculating the orientation of the drone based on at least the one or more first measurement values and the one or more second measurement values.

In another exemplary aspect, a computer program product is provided that includes a memory; and a control unit having a processor that is configured to execute instructions on the memory, that, when executed, cause the processor to retrieve measurement values from one or more MEMS gyroscopes of a drone that includes a main body and a camera device that is attached to the main body with an attachment structure that enables the camera device to be moved in relation to the main body, retrieve one or more first measurement values from the one or more MEMS gyroscopes when the camera device is in a first position in relation to the main body of the drone, shift the camera device from the first position to a second position in relation to the main body of the drone, retrieve one or more second measurement values from the one or more MEMS gyroscopes when the camera device is in the second position, and calculate the orientation of the drone based on at least the one or more first measurement values and the one or more second measurement values.

In another exemplary aspect, a system is provided that includes a drone having a main body, a camera device that is attached to the main body with an attachment structure that enables the camera device to be moved in relation to the main body, and one or more MEMS gyroscopes; and a control unit that is configured to retrieve measurement values from the one or more MEMS gyroscopes, retrieve one or more first measurement values from the one or more MEMS gyroscopes when the camera device is in a first position in relation to the main body of the drone, shift the camera device from the first position to a second position in relation to the main body of the drone, retrieve one or more second measurement values from the one or more MEMS gyroscopes when the camera device is in the second position, and calculate the orientation of the drone based on at least the one or more first measurement values and the one or more second measurement values.

The exemplary aspects of the disclosure are based on the idea of having the drone determine its geographical heading with a gyrocompass located on a camera device on the drone. An advantage of this arrangement is that the orientation of the drone can be calculated before the drone takes off.

### BRIEF DESCRIPTION OF THE DRAWINGS

In the following, the disclosure will be described in greater detail by exemplary embodiments with reference to the accompanying drawings, in which:

FIG. 1 illustrates an airborne drone with a camera according to an exemplary aspect.

FIGS. 2a-2c illustrate a stationary drone according to an exemplary aspect.

FIGS. 3a-3d illustrated gyroscope orientations in the horizontal plane and bias error calculations according to an exemplary aspect.

FIG. 4 illustrates a method for determining a drone orientation according to an exemplary aspect.

### DETAILED DESCRIPTION

Exemplary aspects of the present disclosure provide for a method and system for determining the orientation of a drone. The drone comprises a main body. The drone also comprises a camera device that is attached to the main body with an attachment structure that allows the camera device to be moved in relation to the main body. The drone also comprises one or more MEMS gyroscopes on the camera device or the attachment structure.

The method comprises providing a control unit which is configured to retrieve measurement values from said one or more MEMS gyroscopes. The method also comprises retrieving in the control unit one or more first measurement values from said one or more MEMS gyroscopes when the camera device is in a first position in relation to the main body of the drone. The method also comprises shifting the camera device from the first position to a second position in relation to the main body of the drone. The method also comprises retrieving in the control unit one or more second measurement values from said one or more MEMS gyroscopes when the camera device is in the second position. The method also comprises calculating the orientation of the drone based on at least the one or more first measurement values and the one or more second measurement values.

The first position differs from the second position, so the shifting of the camera device from the first position to the second position involves a change in the position of the camera device in relation to the main body of the drone.

The main body of the drone may be stationary when the one or more first measurement values are retrieved in the control unit. In this disclosure, a drone is considered “stationary” when it does not move in relation to the surface of the Earth. The main body of the drone may remain stationary when the camera device is shifted from the first position to the second position. The main body of the drone may also be stationary when the one or more second measurement values are retrieved in the control unit, and when any optional additional measurements are performed in additional third, fourth, fifth, etc., positions. The drone can be configured, for example, to rest on a surface, hang from a launchpad or be held either by human hands or by a gripping tool when the method is performed.

The surface, launchpad, human or gripping tool may be called a takeoff arrangement. The takeoff arrangement may rest on the ground or be fixed to an object which rests on the ground. The stationary drone may be attached to the takeoff arrangement by the force of gravity when the method is performed. Alternatively, the stationary drone may be attached to the takeoff arrangement by a force applied by a human (the grip of a hand, for example) or by a mechanical force actuator (the grip of a gripping tool). The propellers of the drone may be turned off (i.e., not rotating) when the method is performed. In other word, the drone may be in a rest state when the method is performed. The drone generates no lift force in its rest state.

However, drones may remain stationary with respect to the surface of the Earth even when in flight. Consequently, the drone may alternatively hover over a certain point when the method is performed. Stationary hovering may for example be executed outdoors when the wind is calm or non-existent, or indoors. In other words, the drone may alternatively be in a flying state (which differs from the rest state) when the method is performed, and still be stationary with respect to the surface of the Earth. Furthermore, the drone does not necessarily have to be stationary with respect to the surface of the Earth when the orientation of the drone is being determined. The drone may for example move in the vertical z-direction, perpendicular to the surface of the Earth, or even fly in the x- and/or y-directions, while the orientation of the drone is determined.

The calculation will typically be more reliable if the drone is resting on some kind of support when the orientation is determined. For simplicity, this disclosure will primarily discuss examples where methods are performed when a drone is resting on a surface. The method may in this case form a part of a launch procedure or takeoff procedure. However, the measurement principles and practical embodiments presented in this disclosure apply equally to situations where the drone is in flight when the method is performed.

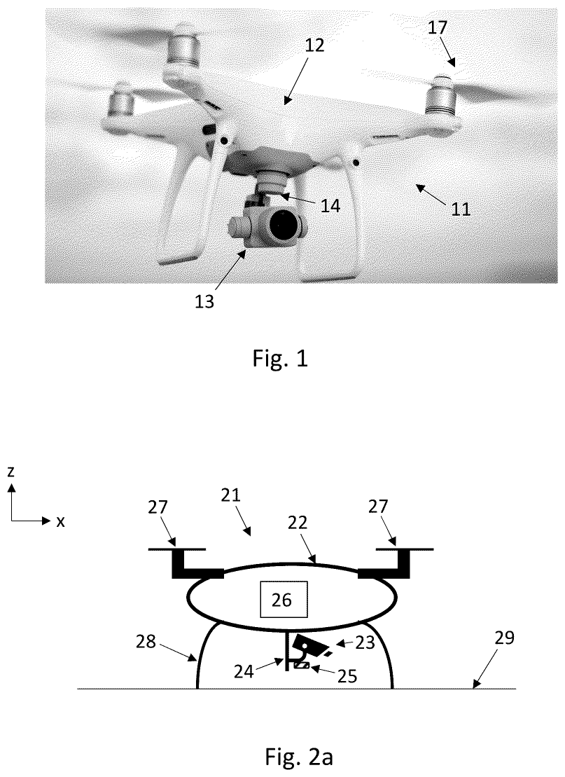

FIG. 1 illustrates an airborne drone 11 with a main body 12 and a camera device 13 according to an exemplary aspect. The camera device 13 is attached to the main body 12 with an attachment structure 14 that either keeps the camera device 13 stationary in relation to the main body 12 or moves the camera device 13 in relation to the main body 12. The attachment structure may comprise a gimbal or some other multiaxial mechanism which allows the camera device to be oriented in any direction, or at least any direction below the main body 12.

The movement of the attachment structure 14 can be controlled by a control unit (not illustrated) that may be located within the main body 12 of the drone. The control unit can also be configured to perform many other functions, such as steering the flight of the drone in a selected direction by controlling the propellers 17. The drone may also comprise communication system that can be configured to (if the control unit is located on the drone) allow a user to send commands to the control unit and retrieve information from the control unit or (if the control unit is not located on the drone) allow the control unit to send commands to the attachment structure 14 and retrieve data from sensors which are located on the drone.

The control unit may be configured to stabilize the camera. The flightpath of a lightweight drone is usually not straight, since even small gusts of wind can alter its course and the user may send steering commands which produce sudden movement. Quick changes in the flightpath could severely degrade the quality of the images or video that the camera device 13 can record if the camera device would be rigidly fixed to a specific position. However, one or more inertial measurement sensors may be placed in or on the camera device 13. The control unit may continuously monitor the movement of the camera device 13 by retrieving one or more corresponding motion signals from these sensors. The sensors may include stabilization gyroscopes and stabilization accelerometers.

The motion signals may indicate the linear and/or rotational movement that the camera device experiences at any moment. The control unit may be configured track the motion signals and to continuously adjust the position and orientation of the camera device 13 in relation to the main body 12 based on the retrieved motion signals. The control unit may transmit commands to the attachment structure 14 to achieve this purpose. The camera device 13 may thereby stabilized, so that it is kept level, pointing in the desired direction, even when the main body 12 undergoes sudden movement which temporarily shifts it away from the intended flightpath.

The control unit may also be configured to return the drone 11 back to the intended flightpath as soon as possible by controlling propellers 17. Additional gyroscopes and accelerometers, which also communicate with the control unit, may be included in the main body 12 of the drone 11 to achieve this flightpath control function.

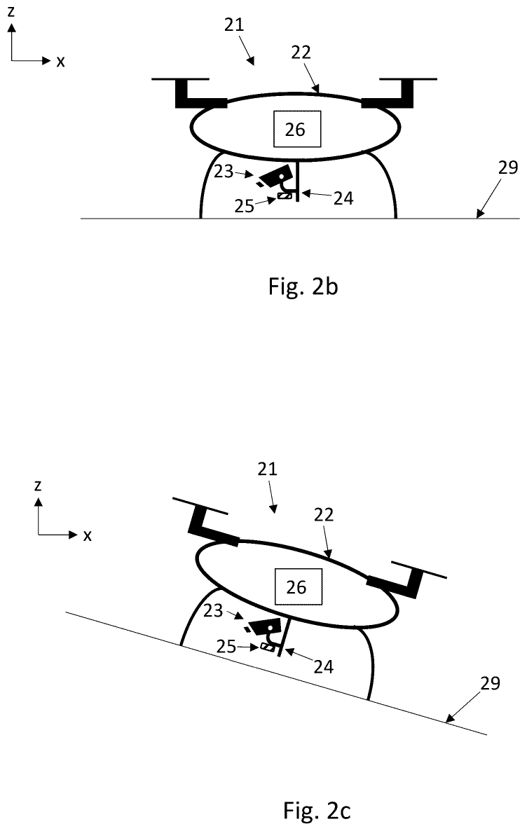

A drone may rest on a surface before take-off. This is illustrated in FIG. 2a, where reference numbers 21, 22, 23, 24 and 27 correspond to reference numbers 11, 12, 13, 14 and 17, respectively, in FIG. 1. FIG. 2a also illustrates the control unit 26 inside the main body 22, and leg supports 28 which may be in contact with the surface 29 when the drone is stationary. Even though the control unit is illustrated inside the main body in FIG. 2a, it does not necessarily have to be located on the drone, as explained in more detail below.

According to the exemplary aspect, the x-axis in FIG. 2a, and in the other figures in this disclosure, illustrates an xy-plane (with the y-axis pointing into the page) which is parallel to the surface of the Earth at the place where the drone 21 is located. The xy-plane may be called the horizontal plane. The z-axis illustrates a direction which is vertical, i.e., perpendicular to the surface of the Earth at the place where the drone 21 is located. The surface 29 where the drone 21 rests in a stationary position may be horizontal, as FIGS. 2a-2b illustrate, but it may alternatively be tilted with respect to the surface of the Earth, as FIG. 2c illustrates.

Furthermore, as mentioned above, the drone 21 does not necessarily have to rest on a surface when the method described in this disclosure is performed. The drone could alternatively be hovering, flying, held by human hands, or it could hang from a launchpad which supports the weight of the drone from above, when the method is performed. The following discussion will refer to procedures for launching the drone from a surface, but it should be understood that the same methods can be used even when no surface is present.

According to the exemplary aspect, the determination of drone orientation can, for example, comprise a determination of true north, which is the direction which is parallel to the Earth's surface and points toward the point where the Earth's rotation axis meets the surface of the Earth. Any other point of the compass could also be used as the reference direction.

The orientation is determined by measurements of rotation rate, performed by MEMS gyroscopes. When the control unit has determined the reference direction (for example true north), it can determine the direction in which the drone should be launched to immediately obtain a given geographical heading, such as southwest.

The method described in this disclosure, which is performed by the control unit, may form a part of a drone launch procedure. This procedure may be performed by the control unit before the drone is launched. The same procedure may for example include checks where the control unit determines before launch that all motors and propellers of the drone are fully functional, that all communication systems are operational, and other steps.

Alternatively or complementarily, the method described in this disclosure may form a part of a calibration or recalibration procedure which can be performed during a flight pause. In other words, a drone may be programmed to fly a predetermined route and to land somewhere along the route. The control unit may be configured to determine the orientation of the drone after the drone has landed, when it is stationary. The drone may take off again when the orientation has been determined. The control unit may be configured to adjust the flightpath of the drone based on the newly calibrated orientation information, so that the drone follows the predetermined route as accurately as possible. The method described in this disclosure can also be used for other purposes.

The drone in FIG. 2a comprises one or more MEMS gyroscopes 25. Each MEMS gyroscope may be a 1-axis gyroscope, which measures the rotation rate around one sense axis, or a 3-axis gyroscope which measures the rotation rate around three sense axes that are perpendicular to each other. If the one or more MEMS gyroscopes comprise more than one MEMS gyroscope, then some of these gyroscopes may be 1-axis gyroscopes, and others may be 3-axis gyroscopes. Alternatively, all gyroscopes may be either 1-axis gyroscopes or 3-axis gyroscopes.

FIG. 2a illustrates a MEMS gyroscope 25 which is attached to the attachment structure 24. The MEMS gyroscope 25 could alternatively be attached to the camera device 23. The MEMS gyroscope is for illustrative purposes shown as a separate block in the figures of this disclosure, but it may in practice be built into the attachment structure 24 or into the camera device 23. It is noted that any MEMS gyroscope 25 described in this disclosure can and will be moved in relation to the main body 22 of the drone when the camera device 23 is moved in relation to the main body 22.

In this disclosure, the expression “the drone is stationary” refers to a situation where the main body 22 of the drone is stationary in relation to the surface of the Earth. By moving the camera device 23 to different positions when the drone is stationary, the one or more MEMS gyroscopes can be used to determine the orientation of the drone with respect to the Earth's rotation axis.

FIG. 2b illustrates the drone in FIG. 2a after the camera device has been rotated 180 degrees about the z-axis. In other words, the shifting of the camera device from the first position to the second position may comprise rotation about a rotation axis which is perpendicular to the surface of the Earth. The shifting of the camera device from the first position to the second position may comprise a rotation of 180 degrees about said rotation axis.

In FIGS. 2a-2b, the drone 21 rests on a surface 29, which is parallel to the surface of the Earth, so the 180-degree rotation can be executed as a simple rotation of the attachment structure 24 in relation to the main body 22. If the drone rests on a tilted or uneven surface, as FIG. 2c illustrates, more complicated movements may be needed for rotation about a rotation axis which is perpendicular to the surface of the Earth. In some cases, the mechanism in the attachment structure may not be able to perform such a rotation. Nevertheless, the orientation of the drone can be determined even if the shifting of the camera device is not rotation about a rotation axis which is perpendicular to the surface of the Earth. The calculation which is needed to determine the orientation just becomes more complicated. The drone may comprise an inclinometer (not illustrated) which can be used to measure if and how much the main body 22 of the drone is tilted with respect to the horizontal plane. The control unit may be configured to retrieve data from the inclinometer when the method described in this disclosure is performed, and to use this data in the calculation where the orientation of the drone is determined.

The rotation rate of the Earth is known. The one or more MEMS gyroscopes are used to measure this rotation when the drone is stationary. The magnitude of the measured rotation depends on how the sense axis of the MEMS gyroscopes is oriented with respect to true north. The difference between true north direction and the sense axis of the gyroscope can therefore in principle be determined directly from a single gyroscope measurement.

However, the rotation rate of the Earth is slow, and measurements performed by MEMS gyroscopes typically includes a bias error which is greater than the signal amplitude caused by this rotation. The bias error therefore limits the ability of MEMS gyroscopes to determine the orientation of the drone. Separate measurements in a first and a second position are therefore used to eliminate the bias error. For example, a 180-degree shift from the first position (where the first measurement values are measured) to the second position (where the second measurement values are measured) can, in the subsequent calculation, effectively cancel the bias error. The shift can alternatively have some other magnitude than 180 degrees.

More accurate cancellation can be achieved by adding additional steps to the method. The camera device may for example be shifted to third, fourth, fifth . . . positions, and the control unit may retrieve corresponding third, fourth, fifth . . . measurement values from the one or more MEMS gyroscopes in these positions while the drone remains stationary. The control unit may then be configured to include these additional measurement values in the calculation of the orientation of the drone.

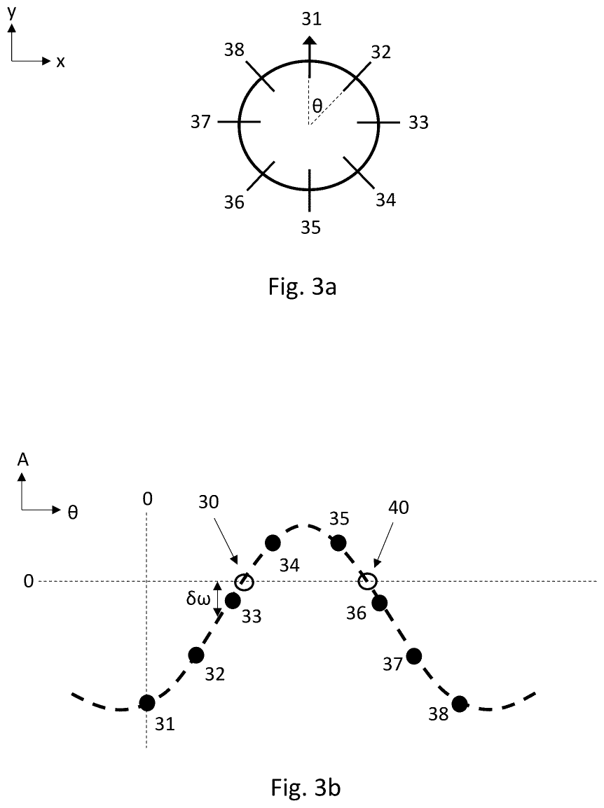

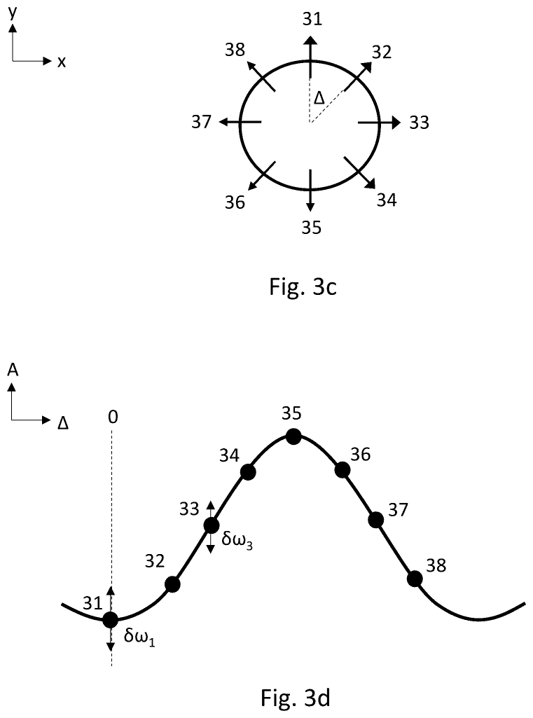

A method involving a single MEMS gyroscope and eight different positions has been schematically illustrated in FIGS. 3a-3b. The arrow 31 in FIG. 3a shows the orientation of one sense axis in the gyroscope (or the projection of the sense axis to the xy-plane, if the sense axis does not lie in the xy-plane) when the camera device is in its first position. Line 32 illustrates the orientation of the same sense axis in the xy-plane after the camera device has been shifted to the second position, and lines 33-38 illustrate the orientation of the same sense axis after the camera device has subsequently been shifted to a third, fourth, fifth, sixth, seventh and eighth position, respectively.

FIG. 3b illustrates the amplitudes of the respective first, second, third . . . and eighth measurement signals retrieved from the MEMS gyroscope in these positions as they measure the rotation rate about the sense axis. Each data point 31-38 has been acquired at the corresponding position in FIG. 3a. The amplitude variable has been plotted as a function of the shift angle θ, which is approximately 45 degrees per shift in FIG. 3a. The bias error 80 of the MEMS gyroscope can be estimated by fitting a sine curve to this data as illustrated, and evaluating how much the curve has been shifted along the A-axis (80) for example by checking where the zero points 30 and 40 on this since curve are located. The sine curve may be of the form A*sin(x+θ)+δω, where A is an Earth rotation amplitude projection to current latitude. Once the bias error has been estimated, the orientation of the gyroscope can be determined by determining the phase angle of the sine-curve. The maximum and minimum point north and south, while the zeros (bias reduced) point east and west.

As indicated above, the estimation could alternatively be conducted with just two of the eight data points 31-38 shown in FIG. 3b. In any embodiment presented in this disclosure, the magnitude of any shift in the position of the camera device may be measured by a gyroscope. If the one or more MEMS gyroscopes that are used to determine the orientation of the drone are 3-axis gyroscopes, then each shift angle θ may be measured by these gyroscopes (since one of the sense axes of the gyroscope is the z-axis). Alternatively, the drone may comprise other gyroscopes which are used for measuring the magnitude of each shift.

If the MEMS gyroscope is a 2-axis or 3-axis gyroscope that can measure the rotation rate about two perpendicular sense axes in the xy-plane, then measurement from both axes may be used when the calculation is performed. Furthermore, if the drone is tilted when the method is performed, as FIG. 2c illustrates, and if this tilt is measured with an inclinometer, then one of the two sense axes may be selected as the preferred sense axis based on the tilt, and measurements from this sense axis may be the only ones which are used in the calculation. The exemplary options described above apply also in the embodiment presented below, where multiple gyroscopes are used, if any or all of these multiple gyroscopes are 3-axis or 2-axis gyroscopes.

In an alternative exemplary aspect, the one or more MEMS gyroscopes may comprise more than one gyroscope, with sense axes pointing in different directions in the horizontal plane. This configuration facilitates a higher accuracy in the fitting of the sine curve and/or a reduction in the number of positional shifts. A single 180-degree shift may be used, and this may be sufficient to map the sine curve. The optimal number of shifts depends on the number of gyroscopes and on the desired accuracy.

A method involving eight MEMS gyroscopes, with eight sense axis pointing in different directions has been schematically illustrated in FIGS. 3c-3d. The arrow 31 in FIG. 3c shows the orientation of one sense axis in a first gyroscope (or the projection of the sense axis to the xy-plane, if the sense axis does not lie in the xy-plane), 32 the sense axis of the second gyroscope, 33 the sense axis of the third gyroscope, and so on. The sense axes point in these directions when the camera device is in its first position. Signal amplitudes obtained from these eight MEMS gyroscopes can be plotted as a function of the angle A, illustrated in FIG. 3c. This angle indicates the angle difference between the sense axes 31 and 32 (and the corresponding difference between sense axes 31 and 33, 31 and 34, etc.) when the camera device is in its first position. By shifting the camera device to a second position (this shift has not been illustrated in FIGS. 3c-3d), performing the measurement again with each of the eight gyroscopes, The bias error can be removed by calculating the difference of the signal between the two positions. The bias is considered to be constant, and as a result is subtracted, while the signal caused by earth rotation, which is orientation-dependent remains. The true orientation can be extracted by fitting the data on to a correct function describing the difference.

In other words, the method may in this case comprise:

Measuring each gyroscope signal ωᵢ in the first position:

$${ω}_{i , n - 1} = A sin ( {θ}_{n - 1} + {φ}_{i} ) + {δω}_{i}$$

In this aspect, A is the earth rotation amplitude projection to current latitude, θ the orientation of the device, φ the relative orientation of the i:th gyroscope to the device, and do the offset for the i:th gyroscope.

Shifting the camera device to the second position for example by rotating it by an angle α around the vertical axis.

Measuring each gyroscope signal in the second position:

$${ω}_{i , n} = A sin ( {θ}_{n} + {φ}_{i} ) + {δω}_{i}$$

Calculating the difference to remove the offset. The remaining part is from earth rotation:

$${ω}_{i , n} - {ω}_{i , n - 1} = ( A sin ( {θ}_{n} + {φ}_{i} ) + {δω}_{i} ) - ( A sin ( {θ}_{n - 1} + {φ}_{i} + α ) + {δω}_{i} ) = A ( sin ( {θ}_{n} + {φ}_{i} ) - sin ( {θ}_{n - 1} + {φ}_{i} + α ) )$$

In this exemplary aspect, α (the rotation about the vertical axis between the two positions) has been added to the n−1 measurement to indicate the shift. For all gyroscopes i, the calculated difference is caused (ideally) by earth rotation. This function can be used to fit the data to obtain A, θ. Φ is known from geometry and a can be obtained by any means described in this disclosure. In the special case where α=180°, the equation reduces to 2A sin(θ+φᵢ).

As in the previous example, if at least some of the MEMS gyroscopes are 3-axis gyroscopes, then each shift angle θ may be measured by those gyroscopes. This measurement may be included in the orientation calculation.

Optionally, the angles of the sense axes of the one or more MEMS gyroscopes may be angled at regular intervals of 360/N, where N is the number of gyroscopes. N may be an even number such that the sense axes of the one or more MEMS gyroscopes are arranged into pairs, wherein the sense axes in each pair are offset by 180 degrees.

In an exemplary aspect, the control unit can be configured to retrieve values for the bias error of each of the sense axes of the one or more MEMS gyroscopes in a lookup table stored in a memory unit, and to subtract the bias error from the received rotation rates before determining the heading of the device.

The control unit can further be configured to retrieve values from the lookup table based on the sum of at least two of the received rotation rates, wherein the at least two received rotation rates are received from sense axes arranged at regular intervals around 360 degrees such that the component of the Earth's rotation in the rate signals is cancelled in the sum of the at least two received rotation rates.

The control unit may be configured to determine the orientation of the drone by fitting a sine or cosine function to the received rotation rates. The sine or cosine function may be fit to the received rotation rates using a least squares mean or other fitting method.

The drone may further comprise a GNSS receiver or a connection for communicating with a GNSS receiver, and prior to sine fitting the received rotation rates, the control unit may be configured to receive the latitude of the device from the GNSS receiver; and calculate the amplitude of the sine function based on the received latitude. The control unit may be configured to determine the heading of the device when the range of values of the received rotation rates is below a threshold. The threshold may be at least 10 times the root mean square error of the received rotation rates.

The drone may further comprises a GNSS receiver or a connection for communicating with a GNSS receiver and an inertial measurement unit, and the control unit may be configured to calculate a heading based on the output of the GNSS receiver and the inertial measurement unit; average the rotation rates of the sense axes received from the one or more MEMS gyroscopes over time; calculate the component of the Earth's rotation felt by each sense axis of the one or more MEMS gyroscopes based on the heading calculated based on the output of the GNSS receiver and inertial measurement unit; and determine the bias error of each sense axis of the one or more MEMS gyroscopes by subtracting the calculated component of the Earth's rotation for each sense axis from the average received rotation rate of the sense axis.

The control unit may be configured to determine the orientation of the drone by receiving first rotation rates from the one or more MEMS gyroscopes at a first position; measuring the shift of the one or more MEMS gyroscopes from the first position to a second position; receiving second rotation rates from the one or more MEMS gyroscopes at the second position; calculating a differential rotation rate for each sense axis of the one or more MEMS gyroscopes by subtracting the second received rotation rate of the sense axis received from the MEMS gyroscope from the first received rotation rate of the sense axis received from the MEMS gyroscope or vice versa; and fitting the differential rotation rates to a sine or cosine function to determine a phase offset of the sine or cosine function, wherein the phase offset corresponds to the heading of the device.

The control unit may be configured to receive multiple first and second rotation rates for each sense axis of the one or more MEMS gyroscopes and to average the received rotation rates over time.

In an exemplary aspect, the drone may comprise two MEMS gyroscopes, wherein the MEMS gyroscopes include at least two sense axes that lie in the horizontal plane perpendicular to one another, and where, in the shift from the first position to the second position, the two MEMS gyroscopes are rotated by 180 degrees with respect to one another such that the sense axes of the MEMS gyroscopes are arranged at 90-degree intervals.

In general, it is noted that in any embodiment presented in this disclosure, the shifting of the camera device in relation to the main body may be performed manually. In other words, a user may grab the camera device and shift it from the first position to the second position, and to subsequent additional positions. The magnitude of this shift may optionally be measured by the one or more MEMS gyroscopes, as explained above.

Alternatively, the control unit may be configured to adjust the position of the camera device in relation to the main body, and the shifting of the camera device from the first position to the second position may be performed by the control unit.

Optionally, the one or more MEMS gyroscopes that are used by the control unit to determine the orientation of the drone may be the same gyroscopes which the control unit uses to stabilize the camera device. In other words, the one or more MEMS gyroscopes may be stabilization gyroscopes, and the control unit may be configured use the one or more MEMS gyroscopes for stabilizing the camera device when the drone is in flight.

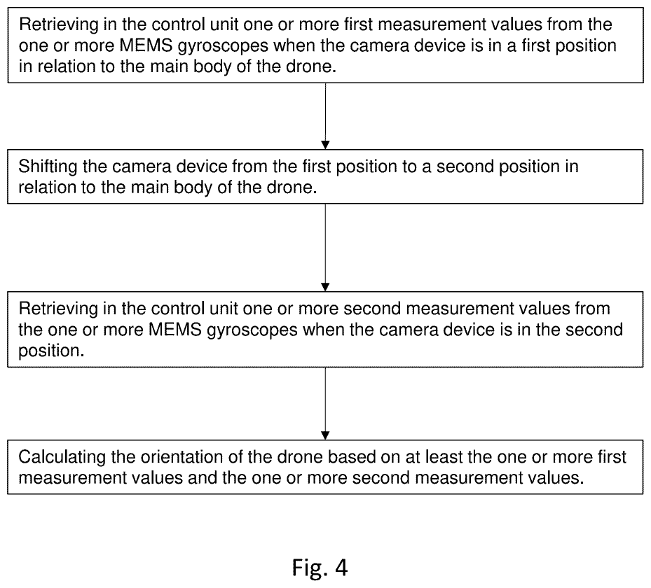

FIG. 4 illustrates the method described in this disclosure. The method may be a computer-implemented method. All calculations described in this disclosure may be performed by the control unit. The results of the calculations may be stored in a memory unit. The control unit may be a part of a computer.

As used herein, the term “computer” refers to physical or virtual computational entities capable of enhancing information and to perform computational tasks according to the exemplary aspect.

The drone may comprise a drone control application running in the control unit on a computer. The computer may be present in the drone, or it may be a cloud-based service located somewhere else. In either case, the user interface of the drone may be a control panel which runs on a portable computer such as a phone or a tablet. The user interface may allow the user to send instructions to the control unit.

The computer where the control unit is located may alternatively be a portable user device, such as a phone, a tablet or any other portable computer.

It is also noted that the exemplary aspects of this disclosure present a computer program product comprising executable instructions which, when executed by a processor, cause the processor to perform a method described in this disclosure. The processor may be located in the control unit.

Moreover, as used herein, the term computer program product refers to a proprietary software enabling a computer or computer system to perform a particular computer-implemented task or tasks. The program product, which may also be called an application, a software application, application program, application software, or app, for example. In at least some of the example embodiments, system software providing a platform for running the application can be considered functionally similar to the application, or as a part of the application. Alternatively or complementarily, a set of instructions based on a mark-up language may also be considered an application. The application may be used on a computer or computing device, in several such devices, on a server or several servers. The program product may utilize cloud computing.

The computer program product may be stored on a computer-readable medium. As used herein, a “computer-readable medium” can be any means that can contain, store, communicate, propagate or transport the program for use by or in connection with the instruction execution system, apparatus or device. The computer readable medium can be, for example, but not limited to, an electronic, magnetic, optical, electromagnetic, infrared or semiconductor system, apparatus, device or propagation medium. A non-exhaustive list of more specific examples of the computer-readable medium can include the following: an electrical connection having one or more wires, a portable computer diskette or memory device, a random-access memory (RAM), a read-only memory (ROM), an erasable programmable read-only memory (EPROM or Flash memory), an optical fibre, and a portable compact disc read-only memory (CDROM).

Finally, this disclosure also presents in FIGS. 2a-2c an arrangement comprising a drone 21 with a main body 22 and a camera device 23. The camera device 23 is attached to the main body 22 with an attachment structure 24 which allows the camera device 23 to be moved in relation to the main body 22. The drone 21 also comprises one or more MEMS gyroscopes 25 in the camera device 23 or the attachment structure 24. The arrangement also comprises a control unit 26, which is configured to perform any method described in this disclosure. In other words, the control unit is configured to retrieve measurement values from said one or more MEMS gyroscopes 25. The control unit 26 is configured to determine the orientation of the drone 21 based on the measurement values retrieved from the one or more MEMS gyroscopes 25. The control unit is also configured to perform the other method steps mentioned above. As explained previously, the control unit 26 may be located in the drone 21 (as FIGS. 2a-2c), but it may alternatively be located somewhere else and connected to the drone with a communication link which allows the control unit to send and retrieve data to and from the various parts of the drone.

In general, it is noted that the exemplary embodiments described above are intended to facilitate the understanding of the present invention and are not intended to limit the interpretation of the present invention. The present invention may be modified and/or improved without departing from the spirit and scope thereof, and equivalents thereof are also included in the present invention. That is, exemplary embodiments obtained by those skilled in the art applying design change as appropriate on the embodiments are also included in the scope of the present invention as long as the obtained embodiments have the features of the present invention. For example, each of the elements included in each of the embodiments, and arrangement, materials, conditions, shapes, sizes, and the like thereof are not limited to those exemplified above and may be modified as appropriate. It is to be understood that the exemplary embodiments are merely illustrative, partial substitutions or combinations of the configurations described in the different embodiments are possible to be made, and configurations obtained by such substitutions or combinations are also included in the scope of the present invention as long as they have the features of the present invention.

What is claimed:

1. A method for determining the orientation of a drone that includes a main body, a camera device that is attached to the main body with an attachment structure that enables the camera device to be moved in relation to the main body, and one or more MEMS gyroscopes, the method comprising:
retrieving, by a control unit, measurement values from the one or more MEMS gyroscopes;
retrieving, by the control unit, one or more first measurement values from the one or more MEMS gyroscopes when the camera device is in a first position in relation to the main body of the drone;
shifting the camera device from the first position to a second position in relation to the main body of the drone;
retrieving, by the control unit, one or more second measurement values from the one or more MEMS gyroscopes when the camera device is in the second position; and
calculating the orientation of the drone based on at least the one or more first measurement values and the one or more second measurement values.

2. The method according to claim 1, wherein the one or more MEMS gyroscopes are on the camera device or the attachment structure.

3. The method according to claim 1, wherein the shifting of the camera device from the first position to the second position comprises rotating the camera device about a rotation axis that is perpendicular to a surface of the Earth.

4. The method according to claim 3, wherein the shifting of the camera device from the first position to the second position comprises rotating the camera device by 180 degrees about the rotation axis.

5. The method according to claim 1, further comprising adjusting, by the control unit, the position of the camera device in relation to the main body.

6. The method according to claim 5, wherein the shifting of the camera device from the first position to the second position is performed by the control unit.

7. The method according to claim 1, wherein the one or more MEMS gyroscopes are stabilization gyroscopes.

8. The method according to claim 7, further comprising using, by the control unit, the one or more MEMS gyroscopes to stabilize the camera device when the drone is in flight.

9. A computer program product comprising:
a memory; and
a control unit having a processor that is configured to execute instructions on the memory, that, when executed, cause the processor to:
retrieve measurement values from one or more MEMS gyroscopes of a drone that includes a main body and a camera device that is attached to the main body with an attachment structure that enables the camera device to be moved in relation to the main body,
retrieve one or more first measurement values from the one or more MEMS gyroscopes when the camera device is in a first position in relation to the main body of the drone,
shift the camera device from the first position to a second position in relation to the main body of the drone,
retrieve one or more second measurement values from the one or more MEMS gyroscopes when the camera device is in the second position, and
calculate the orientation of the drone based on at least the one or more first measurement values and the one or more second measurement values.

10. The computer program product according to claim 9, wherein the one or more MEMS gyroscopes are on the camera device or the attachment structure.

11. The computer program product according to claim 9, wherein the processor, when executing instructions on the memory, is further configured to shift the camera device from the first position to the second position by rotating the camera device about a rotation axis that is perpendicular to a surface of the Earth.

12. The computer program product according to claim 11, wherein the processor, when executing instructions on the memory, is further configured to shift the camera device from the first position to the second position by rotating the camera device by 180 degrees about the rotation axis.

13. The computer program product according to claim 9, wherein the processor, when executing instructions on the memory, is further configured to adjust the position of the camera device in relation to the main body.

14. The computer program product according to claim 9, wherein the one or more MEMS gyroscopes are stabilization gyroscopes.

15. The computer program product according to claim 14, wherein the processor, when executing instructions on the memory, is further configured to use the one or more MEMS gyroscopes to stabilize the camera device when the drone is in flight.

16. A system comprising:
a drone having a main body, a camera device that is attached to the main body with an attachment structure that enables the camera device to be moved in relation to the main body, and one or more MEMS gyroscopes; and
a control unit that is configured to:
retrieve measurement values from the one or more MEMS gyroscopes,
retrieve one or more first measurement values from the one or more MEMS gyroscopes when the camera device is in a first position in relation to the main body of the drone,
shift the camera device from the first position to a second position in relation to the main body of the drone,
retrieve one or more second measurement values from the one or more MEMS gyroscopes when the camera device is in the second position, and
calculate the orientation of the drone based on at least the one or more first measurement values and the one or more second measurement values.

17. The system according to claim 16, wherein the one or more MEMS gyroscopes are on the camera device or the attachment structure.

18. The system according to claim 16, wherein the control unit is further configured to shift of the camera device from the first position to the second position comprises rotating the camera device about a rotation axis that is perpendicular to a surface of the Earth.

19. The system according to claim 16, wherein the control unit is further configured to adjust the position of the camera device in relation to the main body.

20. The system according to claim 16, wherein:
the one or more MEMS gyroscopes are stabilization gyroscopes, and
wherein the control unit is further configured to use the one or more MEMS gyroscopes to stabilize the camera device when the drone is in flight.
